(19) United States
(12) Patent Application Publication
(10) Pub. No.: US 2022/0123669 A1
(43) Pub. Date: Apr. 21, 2022

(54) Solar Micro-Inverter

(71) Applicant: Siemens Aktiengesellschaft, München (DE)

(72) Inventors: Christopher Fromme, Fürth (DE); Marvin Tannhäuser, Hausen (DE)

(73) Assignee: Siemens Aktiengesellschaft, München (DE)

(21) Appl. No.: 17/298,361

(22) PCT Filed: Nov. 29, 2018
(86) PCT No.: PCT/EP2018/083013

§ 371 Date: May 28, 2021

(51) Int. Cl. H02M 7/5387; H02J 3/38; H02M 1/00; H02M 7/00; H02M 3/158; H02M 1/38

(52) U.S. Cl. CPC H02M 7/5387; H02J 3/381; H02M 1/0009; H02J 2300/24; H02M 1/007; H02M 3/1582; H02M 1/38; H02M 7/003

(57) ABSTRACT

Various embodiments of the teachings herein include a solar micro-inverter for converting a DC voltage provided by a solar panel to an AC voltage, the solar micro-inverter including an electrical circuit without a transformer. The solar micro-inverter has an installation height of no more than 24 mm.

### CROSS-REFERENCE TO RELATED APPLICATIONS

This application is a U.S. National Stage Application of International Application No. PCT/EP2018/083013 filed Nov. 29, 2018, which designates the United States of America, the contents of which are hereby incorporated by reference in their entirety.

### TECHNICAL FIELD

The present disclosure relates to a solar energy. Various embodiments of the teachings herein may include solar micro-inverters.

### BACKGROUND

Photovoltaic systems play an increasingly important role in the supply of electrical energy. A photovoltaic system comprises a plurality of solar panels (=photovoltaic modules) that generate electrical energy when exposed to sunlight. The solar panels are typically installed side-by-side, for example by being arranged in a rectangular pattern on a house roof.

There are several options for the electrical connection. The solar panels can be interconnected in one or more series, with one series being referred to as a “string”. A converter is then provided for each string or for the entire photovoltaic system, which converts the resulting DC voltage from the solar panels to an AC voltage. While the power electronics are advantageously bundled in this configuration, the power of a string depends on each of the solar panels being optimally illuminated. Shading or other influences on one or a few solar panels deteriorate the performance of the string disproportionately.

An alternative is the use of what are known as optimizers, which are DC/DC converters and are arranged on each of the solar panels and carry out what is known as maximum power point tracking (MPP tracking) there. As a result, performance deficits of one solar panel do not have a negative effect on other solar panels of the same string, but additional power electronics are required on each panel.

In a further alternative, solar micro-inverters are used. These are also arranged on each of the solar panels and convert the generated DC voltage to AC voltage. The power electronics are decentralized as a result and the overall or string converter can be omitted. The solar micro-inverters also perform the MPP tracking. This results in further advantages. For example, the solar micro-inverters make it possible to work with significantly lower voltage.

Known solar micro-inverters comprise a transformer and filter elements. The inductive and capacitive components largely determine the dimensions of the solar micro-inverter due to their relative bulkiness. A solar micro-inverter arranged on the rear side of a solar panel (side facing away from the sun) thus also protrudes over the frame of a solar panel, which surrounds the actual solar cell surface. Placing the solar panel flat on an even surface is therefore not possible, which makes handling and assembly more difficult.

### SUMMARY

The teachings of the present disclosure include solar micro-inverters that may reduce or solve the problem mentioned at the beginning. For example, some embodiments of the teachings herein may include a solar micro-inverter (2) for converting a DC voltage provided by a solar panel (1) to an AC voltage, wherein the solar micro-inverter (2) is constructed without a transformer and has an installation height of at most 24 mm.

In some embodiments, the system has an installation height of at most 20 mm.

In some embodiments, there is a galvanically coupled electrical converter for converting the DC voltage applied to first connections (11A, 11B) to an output voltage, having: a boost converter connected on the input side to the first connections (11A, 11B), an inverting buck-boost converter connected on the input side to the first connections (11A, 11B) and a series circuit composed of two capacitors (C1, C2) connected to the output-side positive pole (13A) of the boost converter and the output-side negative pole (13B) of the inverting buck-boost converter, wherein the output-side negative pole of the boost converter and the output-side positive pole of the inverting buck-boost converter are connected to the center connection (12A) between the capacitors (C1, C2).

In some embodiments, the boost converter comprises a first series circuit composed of a first semiconductor switch (S1) or a first diode with a second semiconductor switch (S2), the external connections of which first series circuit form the output-side poles of the boost converter, and a first inductance (L1), which is connected to the center connection (12B) of the first series circuit and the positive pole (11A) of the input voltage.

In some embodiments, the inverting buck-boost converter comprises a second series circuit composed of a third semiconductor switch (S3) with a fourth semiconductor switch (S4) or a second diode, one external connection of which forms the output-side negative pole (13B) of the inverting buck-boost converter and the other external connection is connected to the positive pole (11A) of the input voltage, wherein the inverting buck-boost converter further comprises a second inductance (L2), which is connected to the center connection (12C) of the second series circuit and to the center connection (12A) between the capacitors (C1, C2).

In some embodiments, at least some of the first to fourth semiconductor switches (S1 . . . 4) are embodied as gallium nitride switches, in particular as self-locking gallium nitride switches or as a cascode with a self-conducting gallium nitride switch.

In some embodiments, a frequency of at least 200 kHz, in particular at least 500 kHz, in a particular configuration at least 1 MHz, is used as the switching frequency for the gallium nitride switches.

In some embodiments, the first and/or second inductance (L1, L2) are circuit board inductances.

In some embodiments, there is a full bridge (V), which is connected on the input side to the output-side poles (13A, 13B) of the boost and inverting buck-boost converters.

In some embodiments, the power semiconductors (57 . . . 10) of the full bridge (V) are operated as commutators at least for a part of the operating time.

In some embodiments, at least some of the half bridges (102) comprise: a first and second semiconductor switch (S1 . . . 4, 57 . . . 10, 108, 110) connected in series, a controller (120) for the semiconductor switches (S1 . . . 4, 57 . . . 10, 108, 110), a line that originates from the connection node (112) of the semiconductor switches (S1 . . . 4, 57 . . . 10, 108, 110), a device (130) for measuring the current in the line, wherein the controller (120) is configured to compare the current with an upper and a lower threshold value (132, 134), to switch off the first power semiconductor (108) when the upper threshold value (132) is reached and to switch on the second power semiconductor (110) after a first dead time has elapsed, and to switch off the second power semiconductor (110) when the lower threshold value (134) is reached and to switch on the first power semiconductor (108) after a second dead time has elapsed.

As another example, some embodiments include a solar panel (1) with a panel surface, which comprises solar cells and a frame (3) enclosing the panel surface and a solar micro-inverter (2) as described herein arranged on the panel surface, wherein the solar micro-inverter (2) does not protrude beyond the frame (3).

### BRIEF DESCRIPTION OF THE DRAWINGS

Further examples and features can be taken from the following description of exemplary embodiments based on the figures. In the figures, identical reference signs denote identical components and functions. In the figures:

FIG. 1 shows a solar panel with a solar micro-inverter in plan view,

FIG. 2 shows the solar panel in side view,

FIG. 3 shows a diagram of the electrical circuit of the solar micro-inverter,

FIGS. 4 and 5 show alternative embodiments for an input stage of the electrical circuit,

FIG. 6 shows another embodiment for the circuit,

FIG. 7 shows a circuit section with a half bridge with a first drive circuit,

FIG. 8 shows a circuit diagram and current profile,

FIG. 9 shows the half bridge with a second drive circuit,

FIG. 10 shows the half bridge with a third drive circuit, and

FIG. 11 shows a simulated switching behavior.

### DETAILED DESCRIPTION

The teachings of the present disclosure include a solar micro-inverter for converting a DC voltage provided by a photovoltaic panel to an AC voltage that has an installation height of at most 24 mm, in particular an installation height of at most 20 mm. A solar panel with a panel surface, which comprises solar cells and a frame enclosing the panel surface and a solar micro-inverter arranged on the panel surface, does not protrude over the frame. In positive terms, “does not protrude” means that the installation height of the solar micro-inverter is at most so large that its maximum elevation over the panel surface corresponds at most to that of the frame.

This ensures that the handling, storage and transport of a solar panel are significantly improved. In particular, the stacking of the solar panels is much less problematic and the solar panels can be transported in a space-saving manner. Damage to components due to improper stacking when the solar micro-inverter protrudes over the edge is also avoided. In some embodiments, the solar micro-inverter is constructed without a transformer. Since a transformer makes a noticeable contribution to the installation height, a transformerless construction of the solar micro-inverter achieves a significant saving in space, which has a particular effect on the height.

In some embodiments, the solar micro-inverter has a galvanically coupled electrical converter for converting the DC voltage applied to first connections to an output voltage. The electrical converter in turn comprises a boost converter connected on the input side to the first connections, an inverting buck-boost converter connected on the input side to the first connections and a series circuit composed of two capacitors connected to the output-side positive pole of the boost converter and the output-side negative pole of the inverting buck-boost converter, wherein the output-side negative pole of the boost converter and the output-side positive pole of the inverting buck-boost converter are connected to the center connection between the capacitors.

Such a converter consisting of a combination of a boost converter with an inverting buck-boost converter can provide a comparatively high output voltage by connecting the outputs in series. Since each of the converters only has to provide about half the output voltage, the respective transformation ratio is significantly reduced compared to the case of a single converter. This makes it possible to also provide a high transformation ratio of, for example, more than 20, in particular more than 25, without a transformer. In addition to improving the efficiency, this primarily saves the installation size of the transformer.

In some embodiments, the boost converter can comprise a first series circuit of a first semiconductor switch or a first diode with a second semiconductor switch. The external connections of the first series circuit in this case form the output-side poles of the boost converter. Furthermore, the boost converter comprises a first inductance, which is connected to the center connection of the first series circuit and to the positive pole of the input voltage. A boost converter is realized in this way. Using a diode makes a unidirectional flow of energy possible. If the first series circuit comprises the first semiconductor switch, both directions of energy flow are supported by the boost converter. In other words, in order to clarify the construction variants, it is repeated that the first series circuit can either have two semiconductor switches or else one semiconductor switch and a diode. Both construction variants can be combined with the variants listed in the following text.

In some embodiments, the inverting buck-boost converter can comprise a second series circuit composed of a third semiconductor switch with a fourth semiconductor switch or a second diode. Of these, one external connection forms the output-side negative pole of the inverting buck-boost converter and the other external connection is connected to the positive pole of the input voltage. Furthermore, the inverting buck-boost converter comprises a second inductance, which is connected to the center connection of the second series circuit and to the center connection between the capacitors. This realizes an inverting buck-boost converter. Using the second diode again makes a unidirectional flow of energy possible. If, in contrast, the second series circuit comprises the fourth semiconductor switch, both directions of energy flow are supported by the inverting buck-boost converter. In other words, in order to clarify the construction variants, it is repeated that the second series circuit can either have two semiconductor switches or else one semiconductor switch and a diode. Both construction variants can be combined with the variants listed in the following text and previously listed variants.

In some embodiments, at least some of the first to fourth power semiconductors can be embodied as wide bandgap switches, in particular gallium nitride switches, in particular as self-locking gallium nitride switches or as a cascode with a self-conducting gallium nitride switch. This makes low-loss switching possible even at very high frequencies. High switching frequencies in turn allow the inductive and capacitive components used for the filtering to be selected to be smaller, which in turn enables the installation space, in particular the installation height, to be reduced. In particular, a frequency of at least 200 kHz, in particular at least 500 kHz, in a particular configuration at least 1 MHz may be used here as the switching frequency for the gallium nitride switches.

What is particularly advantageous about the use of wide bandgap switches and the associated high switching frequency is that the first and/or second inductance can be selected to be smaller and can therefore be implemented as circuit board inductances. These make a further reduction in the required installation height possible.

In some embodiments, the electrical converter comprises a full bridge, which is connected on the input side to the output-side poles of the boost and inverting buck-boost converters. In particular, the solar micro-inverter is configured in such a way that the power semiconductors of the full bridge are operated as commutators at least for a part of the operating time. The power semiconductors of the full bridge can be MOSFETs, GaN switches, or other semiconductor switches.

In some embodiments, at least some of the half bridges comprise a first and second power semiconductor connected in series, a controller for the power semiconductors, a line that originates from the connection node of the power semiconductors and a device for measuring the current in the line. The controller is configured in this case to compare the current with an upper and a lower threshold value and to switch off the first power semiconductor when the upper threshold value is reached and to switch on the second power semiconductor after a first dead time has elapsed. Furthermore, the controller is configured to switch off the second power semiconductor when the lower threshold value is reached and to switch on the first power semiconductor after a second dead time has elapsed.

In some embodiments, when driving the relevant half bridges with a first and second power semiconductor connected in series, the current in a line originating from the connection node of the power semiconductors is thus measured and compared with an upper and a lower threshold value, the first power semiconductor is switched off when the upper threshold value is reached and the second power semiconductor is switched on after a first dead time has elapsed, and the second power semiconductor is switched off when the lower threshold value is reached and the first power semiconductor is switched on after a second dead time has elapsed.

When the upper threshold value is reached in this case means that it is reached or exceeded in the sense of “greater than or equal to” or only exceeded in the sense of “greater than”. Analogously, when the lower threshold value is reached means that it is reached or undershot in the sense of “less than or equal to” or only undershot in the sense of “less than”. The flow of power of the half bridge can run from the line to the external connections of the power semiconductors or vice versa. The direction of current flow in the line can be directed away from the power semiconductors, which is considered herein as a positive current flow, or it can be directed toward the power semiconductors, which is considered to be a negative current flow. The device for measuring the current can be provided near the half bridge in the line. In some embodiments, the device can also be arranged in a return line from a load to one of the external connections of the power semiconductors, whereby the current in the line is measured despite the different placement. In particular, the inductive load or part of the inductive load can thus be arranged between the location of the current measurement and the half bridge.

In other words, a fixed switching frequency that defines the switching times of the power semiconductors is thus not selected, but the switching of the power semiconductors is carried out on the basis of measured current values and threshold values for the current. If, for example, a change in the load of the half bridge thus leads to the temporal change in current becoming smaller, then the time until the current reaches one of the threshold values lengthens and switching times move further apart from one another. This corresponds to a reduction in the switching frequency. The resulting switching frequency is between 100 kHz and 500 kHz, for example.

This makes it possible to directly select the average value for the current and to directly select the ripple current. The desired average value of the current is implemented by the controller within just one period. Particularly with high switching frequencies, this can be viewed as P behavior, which simplifies the control enormously. In the case of digital controls, this method also makes it possible to keep the control frequency well below the switching frequency. With the previous methods, this would lead to difficulties because there is usually a more complex time behavior. The method therefore makes it possible in the first place to control systems with very high switching frequencies (several 100 kHz up to the megahertz range) even without great computation power, for example with simple and inexpensive microcontrollers. In addition, this method is very robust with changing input and output voltages and therefore creates extensive possibilities in system design. In some embodiments with this half bridge, the ripple current can be selected independently of the operating point, which was not possible with previous methods.

In some embodiments, even given changes in the current behavior, for example due to load changes, the current remains in the range of the threshold values and thus at the average current value that is predetermined as the setpoint value, since the switching behavior of the power semiconductors is matched to the current behavior by the threshold values and the current measurement. The same also applies to changes in the predefined values. If, for example, the setpoint value for the average current—and thus the threshold values—is increased, the current reaches the upper threshold value later or the lower threshold value earlier than before, which shifts the switching times of the power semiconductors and raises the average current value to the new desired value.

In some embodiments, with the high switching frequencies that can now be achieved in a comparatively simple manner, the installation-space-intensive inductive and capacitive components can be reduced in size, and installation space and, in particular, installation height can thus be saved. Other possible features and measures include:
The circuit of the solar micro-inverter can have a fifth semiconductor switch between the first inductance and the positive pole of the input voltage. In this case, the circuit also comprises a sixth semiconductor switch or a third diode between the first inductance and the negative pole of the input voltage. Normally, based on its principle, the boost converter can only generate higher voltages than the input voltage at its output. By way of the fifth and sixth semiconductor switches, it is advantageously possible to also present voltages that are smaller than the input voltage. If the circuit has the sixth semiconductor switch, both directions of energy flow are supported. If the circuit has the third diode, the direction of energy flow is supported by the input voltage side.
The circuit can comprise a third inductance, which is connected in series in the first series circuit between the first semiconductor switch or the first diode and the second semiconductor switch. This further increases the possible transformation ratio for the boost converter. In this case, the first and third inductance are constructed as a common inductance with a center tap for the second semiconductor switch. Common inductance means here that the inductances have a common magnetic circuit, that is to say are arranged on a common core.
The circuit can comprise a fourth inductance, which is connected in series in the second series circuit between the third semiconductor switch and the fourth semiconductor switch or the second diode. This further increases the possible transformation ratio for the inverting buck-boost converter. In this case, the second and fourth inductance are constructed as a common inductance with a center tap for the third semiconductor switch. Like with the first and third inductance, common inductance means here that the inductances have a common magnetic circuit, that is to say are arranged on a common core.
The semiconductor switches of the boost converter and the inverting buck-boost converter can be operated by the control device with staggered clocking. This has the effect that the switching frequency of the circuit appears to be doubled compared to the switching frequency of the semiconductor switches, for example in the boost converter. This reduces the size required for the inductances and capacitances of EMC filters, for example at the input of the converter. This makes the components significantly smaller and lighter. Since the size and weight of these components typically make up a significant proportion of the overall size and the overall weight of a converter, this makes the entire converter significantly smaller and lighter.
The boost converter and the inverting buck-boost converter can be operated in such a way that their output voltages are the same. In some embodiments, they can be operated so that their output voltages are different from each other.
The controller can comprise a first and a second comparator, to which the measured current is fed as the first input signal, wherein the upper threshold value is fed to the first comparator as a second input signal and the lower threshold value is fed to the second comparator as a second input signal. The controller can comprise a digital controller, which forwards the upper and lower threshold value to the comparators via a D/A converter (digital-to-analog converter, DAC). The outputs of the comparators can be converted to control signals for the power semiconductors in a modulator. The result is a simple construction, since microcontrollers are now available in which D/A converters, comparators and the modulator are integrated. The methods can thus be implemented without additional hardware.
The controller can calculate the threshold values from values that can be predetermined for the average value of the current and for the ripple current in the output line. For example, the threshold values can be calculated from the sum and difference of the average value and ripple current. In some embodiments, only values relevant to the operation then have to be predetermined from outside the controller, while the controller generates the correct control values from them.
The controller can be configured to use a minimum value for the ripple current. In other words, the controller can force a minimum spacing between the upper and lower threshold value to be maintained, wherein this minimum spacing corresponds to the minimum value for the ripple current. In some embodiments, the switching frequency resulting from the spacing between the threshold values, which increases as the ripple current decreases, does not become too high.
The controller can use values that characterize different current directions as the upper and lower threshold value. The threshold value that is lower in terms of magnitude can be selected in each case so that it has a different sign than the desired average current. This allows the output capacitances of the power semiconductors to be recharged. This in turn makes it possible to switch on the power semiconductors at low voltage, ideally without voltage. In other words, the ripple current is selected here to be so large that the threshold values have different signs, that is to say they characterize different current directions. Half the amplitude of the ripple current is then greater than the average current value. It may also be sufficient to use the value 0 A as one of the threshold values. This also allows the output capacitances of the power semiconductors to be recharged and thus makes possible voltage-free switch-on.
In some embodiments, the controller can calculate that threshold value that characterizes a current direction other than the current direction of the average value for the current from the summed output capacitance of the power semiconductors, the inductance in the output line and the voltage at the input and output of the half bridge.
The controller can set the dead times in such a way that the power semiconductors are switched on without voltage. This results in a considerable reduction in switching losses. Furthermore, a considerable improvement in the EMC properties is also achieved, since a resonant oscillation process takes place. This makes the edges of the switching voltage significantly flatter and rounded. The spectrum of such a switching voltage shows considerably lower amplitudes in the harmonics.
The controller can calculate the dead times for this or select them from a stored value table. The calculation can be done, for example, from the summed output capacitance of the power semiconductors, the inductance in the output line and the voltage at the input and output of the half bridge. In some embodiments, the half bridge can have means for measuring the voltage across the first and second power semiconductors. Switching can then take place on the basis of the measured voltage, which enables reliable resonant switching.
In some embodiments, the first and second dead times are different from one another, since the recharging of the capacities of the power semiconductors takes place at different absolute currents and thus takes different lengths of time.

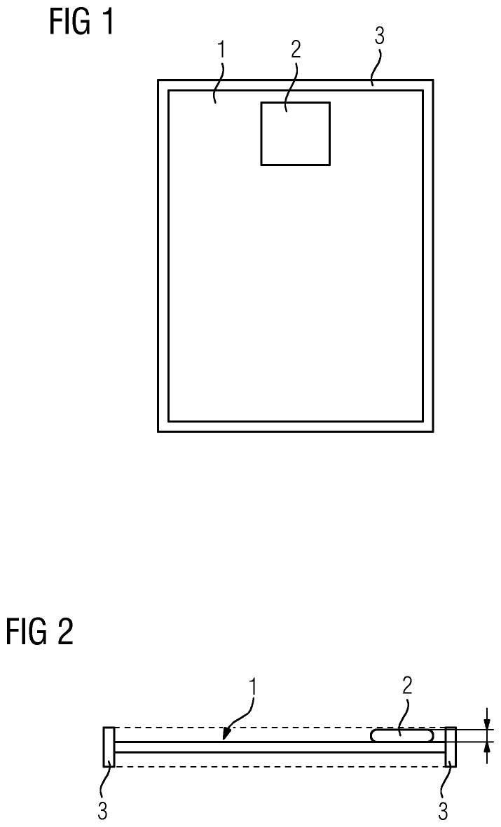

FIG. 1 shows a schematic plan view of the rear side of an exemplary solar panel 1 with a solar micro-inverter 2 associated with the solar panel 1. The solar micro-inverter 2 is arranged near a side edge of the solar panel 1. The solar panel 1 is enclosed by a frame 3. FIG. 2 shows a side view of the solar panel 1. In the side view, it can be seen that the solar micro-inverter 2 rests on the rear side of the solar panel 1. The solar micro-inverter 2 in this case is so flat that it does not protrude over the frame 3. In other words, the height of the solar micro-inverter 2 is less than the protrusion of the frame over the rear side of the solar panel 1. For this purpose, the height of the solar micro-inverter 2 in this example is 22 mm, with other possible values for the height being 24 mm, 20 mm, or 19 mm. In the side view, it can be seen that, because the solar micro-inverter 2 does not protrude over the frame 3, such a solar panel 1 can be surrounded with a packing, the dimensions of which are not influenced by the solar micro-inverter 2, but rather their size is only given by the frame 3.

In order to achieve the low height in comparison to known solar micro-inverters, it is necessary to bring about a reduction in the required size, especially in the case of the passive components, particularly in the case of inductive and capacitive components.

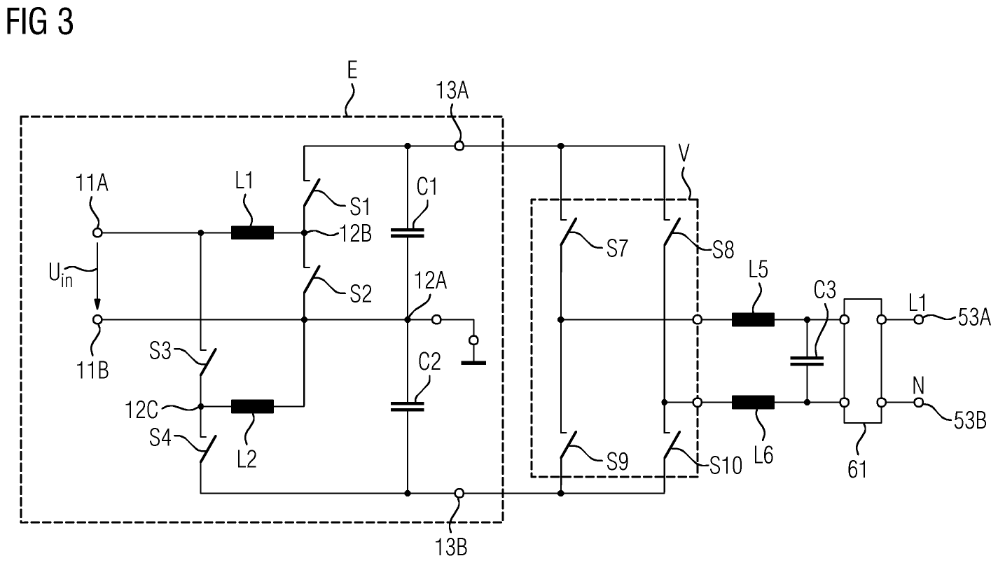

In this exemplary embodiment, a circuit in the solar micro-inverter 2 is used for this purpose, which is shown schematically in FIG. 3. The circuit comprises an input stage E, a full bridge V and an output filter. The structure of the input stage E corresponds to an interconnection of a boost converter and an inverting buck-boost converter, wherein the respective outputs are connected in series. The input stage E has a first and second input connection 11A, 11B for the input voltage, wherein the first input connection 11A is to be used as a positive pole. Furthermore, the input stage E has a first and a second output connection 13A, 13B, wherein the first output connection 13A likewise typically represents the positive pole. The input stage E also has three electrical nodes 12A, 12B, 12C, on the basis of which the construction is described.

The first node 12A is directly connected to the second input connection 11B and furthermore connected to ground. A first inductance L1 is arranged between the first input connection 11A and the second node 12B. A first semiconductor switch S1 is arranged between the first output connection 13A and the second node 12B. A second semiconductor switch S2 is arranged between the second node 12B and the first node 12A. A first capacitor C1, which represents the output of the boost converter, which is formed from the first diode D1, the second semiconductor switch S2 and the first inductance L1, is arranged between the first output connection 13A and the first node 12A. A third semiconductor switch S3 is arranged between the first input connection 11A and the third node 12C. A fourth semiconductor switch S4 is arranged between the second output connection 13B and the third node 12C. A second inductance L2 is arranged between the third node 12C and the first node 12A. A second capacitor C2, which represents the output of the inverting buck-boost converter, which is formed from the second diode D2, the third semiconductor switch S3 and the second inductance L2, is arranged between the second output connection 13B and the first node 12A. The semiconductor switches S1 . . . 4 in the converter 10 are GaN switches in this example. These enable a particularly high switching frequency, which in turn ensures that passive components can have a smaller design size. Other wide bandgap switches can also be used in place of the GaN switches. The switching frequency for these switches is variable, as described below, and is between values of approximately 100 kHz and approximately 500 kHz.

When the circuit is in operation, the boost converter generates a positive voltage at the first capacitor C1. In principle, this positive voltage is at least as great as the input voltage at the input connections 11A, 11B. The inverting buck-boost converter in turn generates a negative voltage at the second output connection 13B relative to the first node 12A. As a result of the series connection of the two capacitors C1, C2, the output voltage between the two output connections 13A, 13B is the sum of the amounts of the two voltages generated. Thus, the transformation ratio that results for a given input and output voltage is halved in each case for the boost converter and the inverting buck-boost converter.

The output connections 13A, 13B of the input stage E are connected to the external connections of the full bridge V. The full bridge V comprises four further semiconductor switches S7, S8, S9, S10. The center connection of a first half bridge of the full bridge V with the seventh and ninth semiconductor switches S7, S9 is connected to a fifth inductance L5. The center connection of the second half bridge of the full bridge V with the eighth and tenth semiconductor switches S8, S10 is connected to a sixth inductance L6. The center connections are also connected via a third capacitor C3. The two center connections are also connected to an EMI filter 61. The output of the EMI filter 61 constitutes the two output connections 53A, 53B for the circuit. A large capacitance (not illustrated in the figure) is present at the circuit input in order to draw as little pulsating power as possible from the solar panels.

A control device for the circuit that drives the semiconductor switches S1 . . . 58 is not illustrated in FIG. 3. To function as an inverter, the first and second semiconductor switches S1, S2, that is to say the boost converter, are driven by way of pulse width modulation in such a way that the profile of the voltage UC1 takes the form of successive half-waves at the output of the boost converter, that is to say at the first capacitor C1. The third and fourth semiconductor switches S3, S4, that is to say the inverting buck-boost converter, are driven in such a way that the profile of the voltage UC2 also assumes the form of successive half-waves at the output of the inverting buck-boost converter, that is to say at the second capacitor C2. In contrast to the typical operation as DC-DC converters, the boost converter and the inverting buck-boost converter are thus now operated in such a way that they each do not generate a constant DC voltage at their output. The polarity of the voltage UC2 at the second capacitor here is such that in total there is an increased amplitude for the voltage profile between the first and second output connection 13A, 13B. Given the same amplitude of the two voltage profiles UC1, UC2, the resulting total is twice the amplitude for the half-wave.

The resulting half-wave is applied to the external connections of the full bridge V. The full bridge V is now driven in such a way that the polarity of the half-wave changes with each half-wave and thus, in the ideal case, a sinusoidal voltage profile results between the center connections of the full bridge V. For this purpose, there is switching between two switching states. In the first switching state, the eighth and ninth semiconductor switches S8, S9 are switched on and the seventh and tenth semiconductor switches S7, S10 are switched off. In the second switching state, the seventh and tenth semiconductor switches S7, S10 are switched on and the eighth and ninth semiconductor switches S8, S9 are switched off. The change between these switching states takes place here with every half-wave. The frequency of the resulting sinusoidal voltage profile expediently corresponds to the frequency of the supply network, that is to say 50 Hz, for example.

The half-waves are then generated in such a way that they follow each other at 100 Hz and the full bridge V must switch the polarity at 100 Hz, so that every two half-waves result in a complete sine wave. It follows from this that the semiconductor switches 57 . . . S10 only have to switch at 100 Hz, which is comparatively seldom for converter conditions. Therefore, switches that are optimized for low conduction losses can be used in the full bridge.

Since the boost converter in the circuit of FIG. 3 is not able to generate a lower voltage than the input voltage at its output, the generated half-wave at the first capacitor C1 is incomplete. In time ranges in which the voltage would have to actually be lower than the input voltage according to the profile of the half-wave, it nevertheless corresponds approximately to the input voltage. The control device may be designed to deal with this problem. For this purpose, the control device can be configured to generate the voltage profile of the sine wave by switching the semiconductor switches 57 . . . S10 of the full bridge V at least in the time ranges mentioned. For this purpose, the semiconductor switches 57 . . . S10 must be switched at high frequency in these time ranges and the voltage form must be set using pulse width modulation. The fifth and sixth inductance L5, L6 as well as the third capacitor C3 are configured for the necessary filtering of the resulting voltage form, even with high-frequency switching of the full bridge V.

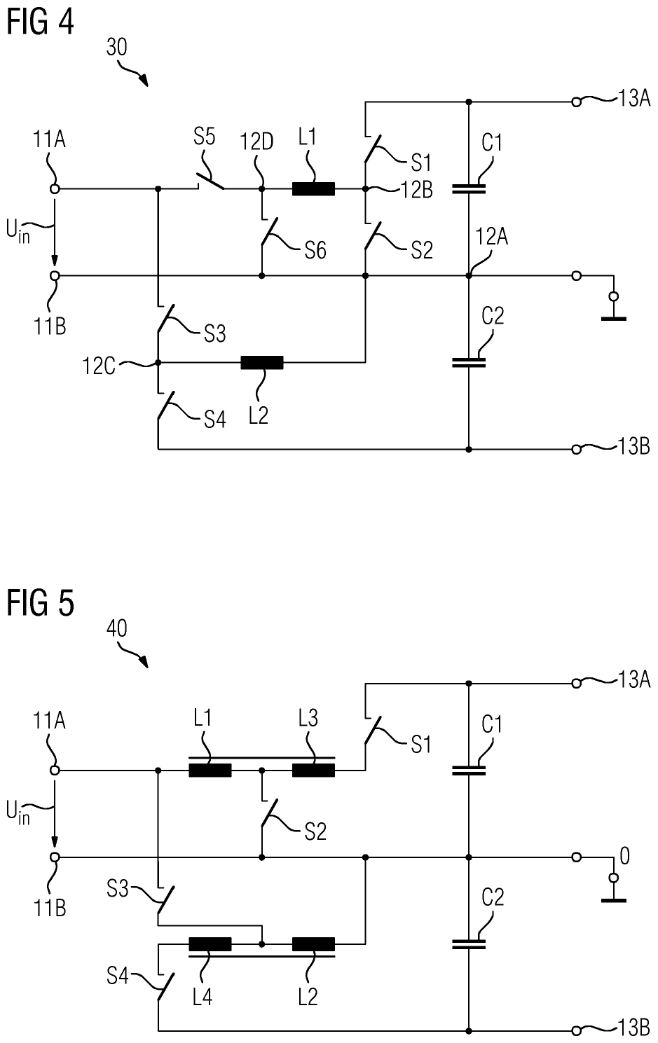

FIGS. 4 and 5 show alternative configurations of the input stage E. The input stage 30 shown in FIG. 4 comprises the components of the input stage E according to FIG. 3. In addition, a fourth node 12D is present between the first inductance L1 and the first input connection 11A. A fifth semiconductor switch S5 is arranged between the fourth node 12D and the first input connection 11A. A sixth semiconductor switch S6 is arranged between the fourth node 12D and the first node 12A.

The additional semiconductor switches S5, S6 in conjunction with the components of the boost converter create a combination of a buck-boost converter. The properties of the boost converter can be established by switching off the sixth semiconductor switch S6 and switching on the fifth semiconductor switch S5. If an output voltage lower than the input voltage is to be generated, the first semiconductor switch S1 can be switched on and the second semiconductor switch S2 can be switched off and thus only the buck converter can be used. The restriction of the converter according to FIG. 3 with regard to the output voltage is thus eliminated and all positive DC voltages and waveforms whose amplitude is not too large can be generated.

In some embodiments, the first, second, fifth and sixth semiconductor switches S1, S2, S5, S6 can be switched diagonally. For this purpose, there is a change between two switching states, wherein the first and sixth semiconductor switches S1, S6 are switched on in the first switching state and the second and fifth semiconductor switches S2, S5 are switched on in the second switching state. In this mode of operation, the boost converter and the buck converter thus act at the same time and not independently of one another.

Another exemplary embodiment for the input stage is illustrated in FIG. 5. The construction of the input stage 40 according to FIG. 5 is based on the input stage according to FIG. 3. In addition to this, however, the input stage 40 has a third inductance L3 between the second node 12B and the first semiconductor switch S1. In this example, the first and the third inductance L1, L3 are constructed as a common inductance with a center tap, to which the second semiconductor switch S2 is connected.

Furthermore, the input stage 40 has a fourth inductance L4 between the third node 12C and the fourth semiconductor switch S4. In this example, analogously to the first and third inductance L1, L3, the second and the fourth inductance L2, L4 are constructed as a common inductance with a center tap, to which the third semiconductor switch S3 is connected. The structure of the input stage 40 according to FIG. 5 makes it possible to achieve even higher transformation ratios between the output and the input voltage.

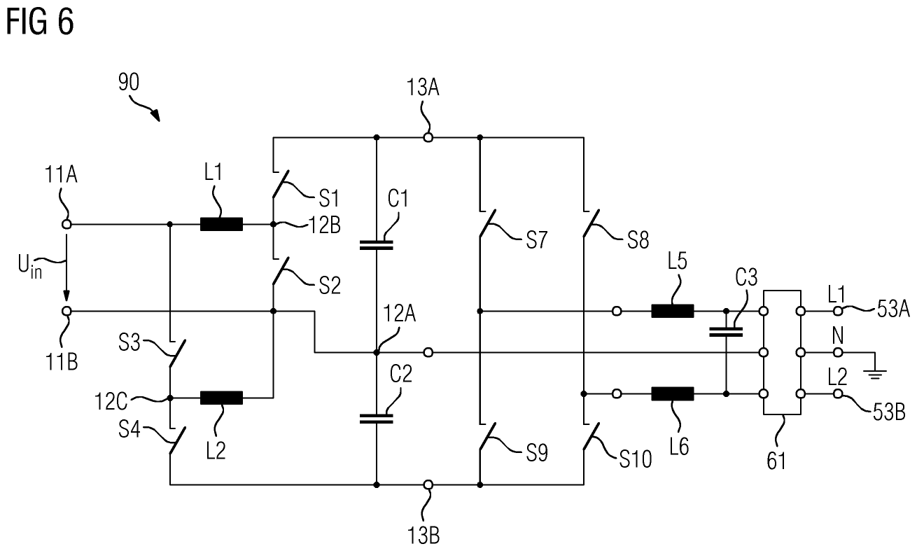

As a further exemplary embodiment for the circuit of the solar micro-inverter 2, FIG. 6 shows an inverter 90, which is configured for use in a split phase grid. The construction of the inverter 90, including the design of the control device, largely corresponds to the construction of the circuit according to FIG. 3. In addition, however, the first node 12A is provided as a further input for the EMI filter 61 and is led out of same as a neutral conductor. The other functionality corresponds to the circuit according to FIG. 3.

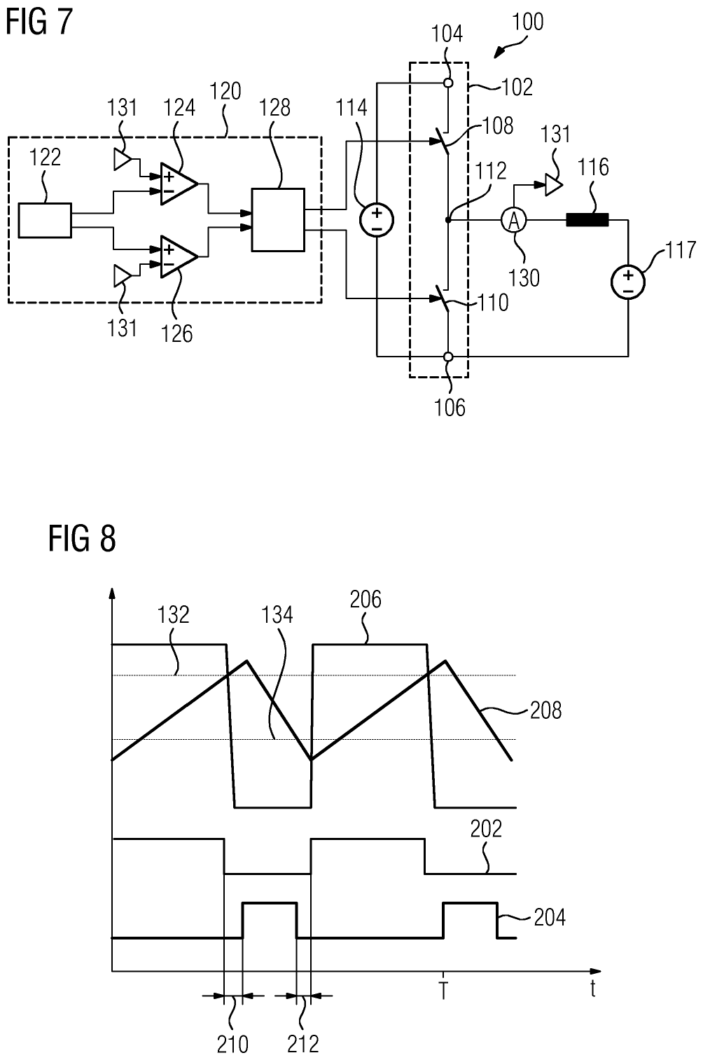

FIG. 7 shows a greatly simplified section of a circuit 100 with a half bridge 102, which corresponds, for example, to the pair of first and second semiconductor switches S1, S2 and/or the pair of third and fourth semiconductor switches S3, S4 in FIG. 3. The half bridge 102 can also be one of the bridges from the full bridge V. The half bridge 102 comprises two power semiconductors 108, 110 such as MOSFETs, for example, connected in series. Often the half bridge 102 is connected using the external connections 104, 106 to a DC voltage 114, for example to the intermediate circuit of a converter. The center connection 112 between the power semiconductors 108, 110 is connected to an inductive load 116. The inductive load 116 is representative of all types of loads that can also be only partially inductive and for structures in which the inductive part of the load is created, for example, by a line inductance. The inductive load 116 can thus just as easily be a dedicated component as a parasitic element or both.

In some embodiments, the driving of the power semiconductors 108, 110 is carried out by a control unit 120. The control unit 120 comprises a digital controller 122, a first and second comparator 124, 126 and a modulator 128. It is possible that these elements are part of a single microcontroller and are thus constructed as a single module. However, these elements can also be present partially or completely as separate components. Furthermore, the control unit 120 comprises a current measuring device 130, which detects the current incoming or outgoing from the center connection 112 as a signal 131.

The first comparator receives as input signals the signal 131 for the measured current and a first threshold value 132 for the maximum current. The second comparator likewise receives as input signals the signal 131 for the measured current and a second threshold value 134 for the minimum current. The threshold values 132, 134 are made available by the controller 122. The controller 122 can calculate this from predefined values for the average current and the current ripple, for example. These predefined values can be predefined externally, for example by a superordinate converter controller, or can be determined by the controller 122 itself. The output signals of the comparators 124, 126 are fed into the modulator 128. The modulator 128 converts these and stored values for dead times to be used to drive signals for the power semiconductors 108, 110, which are passed on to the respective gate driver.

By comparing the measured current with the threshold values 132, 134 for the maximum and minimum current and passing it on to the modulator 128, the active power semiconductor 108, 110 is switched off when the maximum current is reached and the other power semiconductor 108, 110 is switched on after waiting for the dead time to prevent a short circuit in the half bridge 102. When the minimum current is reached, the active power semiconductor 108, 110 is also switched off and the other power semiconductor 108, 110 is switched on after waiting for the dead time.

A resulting circuit diagram with a switching profile 202 for the upper power semiconductor 108, a switching profile 204 for the lower power semiconductor 110, a voltage profile 206 across the lower power semiconductor 110 are illustrated in FIG. 8 together with a resulting simplified current profile 208. The dead times 210, 212, which elapse after a respective power semiconductor 108, 110 has been switched off, are greatly lengthened here for better visibility. FIG. 8 shows that the resulting current profile is approximately triangular.

If the current profile is flatter at any given time, the corresponding threshold value 132, 134 is reached later and the corresponding power semiconductor 108, 110 is only switched off later. The procedure described for controlling the power semiconductors 108, 110 therefore does not work with a fixed switching frequency. Instead, the instantaneous effective switching frequency results from the predefinitions of the threshold values 132, 134 or the predefinitions for the average current and the ripple current, the inductance 116 and the voltages 114, 117, which help to determine the current gradient. The instantaneous switching frequency can therefore also fluctuate and can change if the predefined values are changed.

In the circuit of FIG. 3, such half bridges can be used if the voltage profile generated is a waveform, for example the sequence of sine half-waves. The half bridges then do not generate these in the otherwise usual pulse width modulation with a fixedly predefined switching frequency, but with a continuously adjusted duty cycle. Instead, the average current value that matches the instantaneous value of the half-wave form is continuously adjusted. The controller 120 defines upper and lower threshold values that match the average current value and thus also vary continuously. The correct voltage results from the circuit of the power semiconductors 108, 110, which in the circuit of FIG. 3 correspond to the pair of first and second semiconductor switches S1, S2 and/or the pair of third and fourth semiconductor switches S3, S4, wherein the circuit follows the threshold values and thus the correct voltage is automatically achieved.

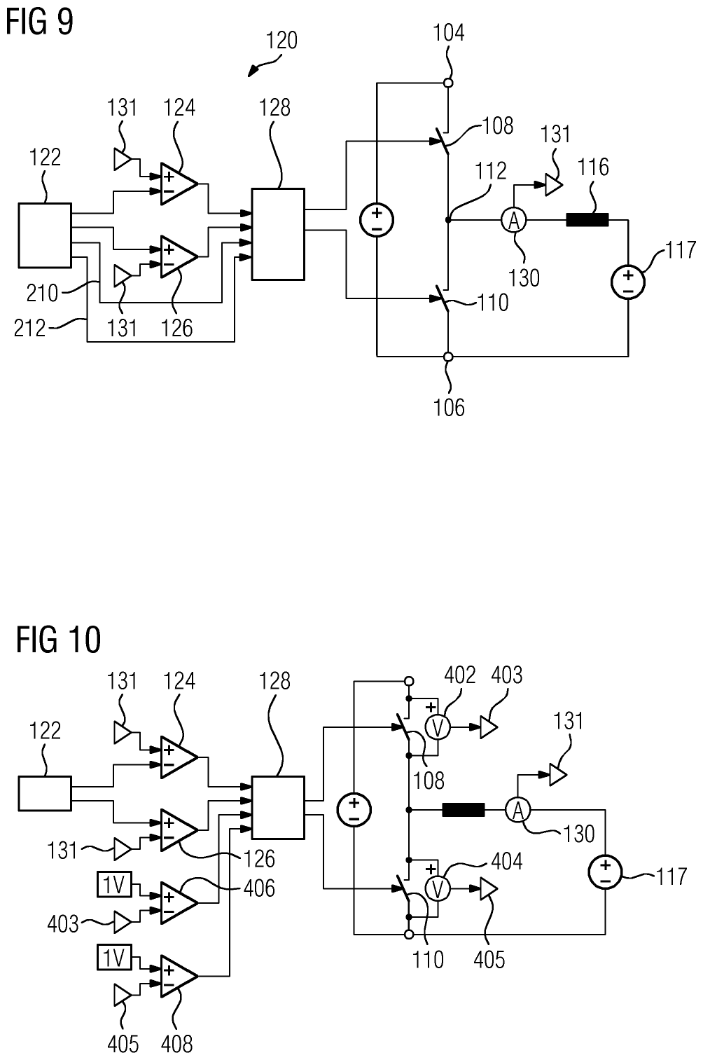

FIG. 9 again shows a section from a circuit with the half bridge, but with a modified structure of the control unit 120. In this case, the dead times 210, 212 are no longer permanently stored in the modulator, but instead predefined by the controller 122. The dead times 210, 212 can therefore be changed by the controller 122 and adapted to the operating situation. Such an adaptation can be used to reduce the switching losses by allowing a resonant recharging of the output capacitances of the power semiconductors 108, 110.

For this purpose, in the case of a positive average value of the current, the threshold value 134 for the minimum current is set to a negative value, that is to say to a value with a different sign to the average value and the threshold value 132 for the maximum current. If the average value of the current is negative, the threshold value 132 for the maximum current is set to a positive value, that is to say again to a value with a different sign to the average value and the threshold value 134 for the minimum current.

The values required for recharging can be calculated as follows to a sufficient approximation:

$${I}_{L} = \sqrt{\frac{C}{L} \cdot ( {( {U}_{1} - {U}_{2} )}^{2} - {U}_{2}^{2} )}$$

In this case:

I_{L} is the lower threshold value 134 for the current

L is the value of the inductance 116 on the output line

U₁ is the voltage across the two power semiconductors 108, 110, that is to say between the upper external connection 104 of the upper power semiconductor 108 and the lower external connection 106 of the lower power semiconductor 110

U₂ is the voltage 117

C is the summed output capacitance of the power semiconductors 108, 110

C=C_{OSS,S1}+C_{OSS,S2}

and

$${I}_{L} = \sqrt{\frac{C}{L} \cdot ( {U}_{2}^{2} - {( {U}_{1} - {U}_{2} )}^{2} )}$$

I_{H} denotes here the upper threshold value 132 for the current

If the term below the root has a value<0, the respective threshold value is set to 0.

The dead times 210, 212 can be determined by the controller 122 in various ways. The suitable determination of the dead times 210, 212 makes it possible for the power semiconductors 108, 110 to be switched on in a voltage-free manner. On the one hand, the dead times 210, 212 can be calculated or read out from a previously determined and stored table (look-up).

To calculate the dead times 210, 212, the following formulae, for example, can be used as a sufficient approximation:

$${t}_{db 1 , min} = \sqrt{L C} \cdot arc cos ( \frac{{U}_{2}}{{U}_{2} - {U}_{1}} )$$

In this case:

t_{db1, min} is the minimum dead time 210 for the upper power semiconductor 108

L is the value of the inductance 116 on the output line

U₁ is the voltage across the two power semiconductors 108, 110, that is to say between the upper external connection 104 of the upper power semiconductor 108 and the lower external connection 106 of the lower power semiconductor 110

U₂ is the voltage 117

C is the summed output capacitance of the power semiconductors 108, 110

$${t}_{db 2 , min} = \sqrt{L C} \cdot ( π - arc cos ( \frac{{U}_{1} - {U}_{2}}{{U}_{2}} ) )$$

In this case:

t_{db2, min} is the minimum dead time 212 for the lower power semiconductor 110

Another possibility is to make a structural adjustment, which is shown in FIG. 10. In the construction according to FIG. 10, the control unit 420 comprises a respective voltage measuring device 402, 404 for each of the power semiconductors 108, 110. The signals 403, 405 of the voltage measuring devices 402, 404 are fed to a third and fourth comparator 406, 408. A fixed low voltage, for example 1 V, is used as the respective second input signal for the third and fourth comparators 406, 408. The output signals of the third and fourth comparator 406, 408 are fed to the modulator 128 and used by the latter in order to use the time at which the voltage across the power semiconductor 108, 110 is low, that is to say 1 V, for example, as the switch-on time for the respective power semiconductor 108, 110.

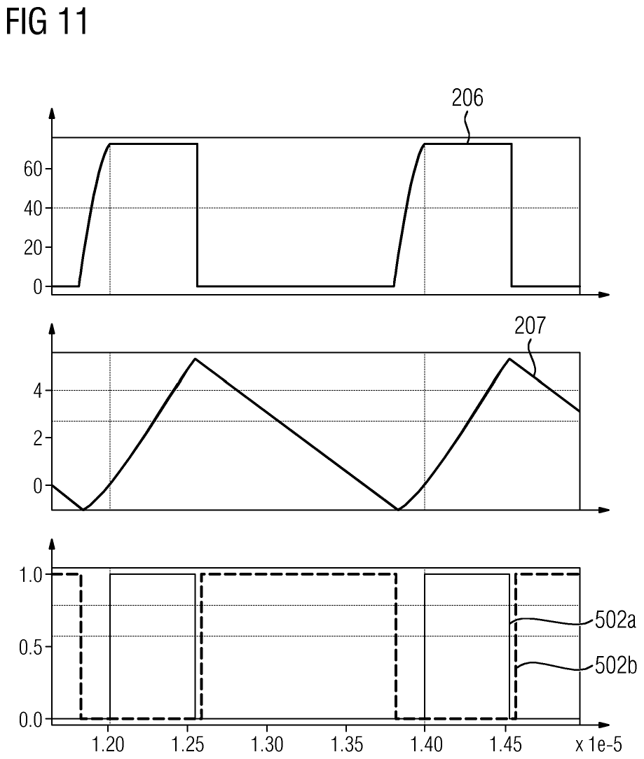

FIG. 11 shows the profile of the voltage 206, the current 207 and the switch-on times 502a, b for the first and second power semiconductors 108, 110 as a result of a simulation. The switching edges of the voltage 206 are noticeably flattened. Here, the output capacitances are recharged before the respective power semiconductor 108, 110 is switched on. This means that it is switched on without voltage. The flatter edges of the switching voltage mean significantly lower amplitudes of the harmonics and therefore also ensure better EMC properties of the construction.

Since the switching frequency can become very high with very low current ripple values, it is advantageous to implement a minimum value for the current ripple. The controller 122 is configured to implement and adhere to this minimum value. This limits the switching frequency to a desired maximum.

What is claimed is:

1. A solar micro-inverter for converting a DC voltage provided by a solar panel to an AC voltage, the solar micro-inverter comprising:
an electrical circuit without a transformer; and
wherein the solar micro-inverter has an installation height of no more than 24 mm.

2. The solar micro-inverter as claimed in claim 1, where the installation height is no more than 20 mm.

3. The solar micro-inverter as claimed in claim 1, further comprising a galvanically coupled electrical converter for converting the DC voltage to an output voltage, the electrical converter including:
first connections to the DC voltage source;
a boost converter connected on the input side to the first connections;
an inverting buck-boost converter connected on the input side to the first connections; and
a series circuit with two capacitors connected to an output side positive pole of the boost converter and an output side negative pole of the inverting buck-boost converter;
wherein the output-side negative pole of the boost converter and the output-side positive pole of the inverting buck-boost converter are connected to a center connection between the capacitors.

4. The solar micro-inverter as claimed in claim 3, wherein:
the boost converter comprises a first series circuit composed of a first semiconductor switch or a first diode with a second semiconductor switch;
external connections of the first series circuit form the output-side poles of the boost converter; and
a first inductance is connected to the center connection of the first series circuit and the positive pole of the input voltage.

5. The solar micro-inverter as claimed in claim 4, wherein:
the inverting buck-boost converter comprises a second series circuit with a third semiconductor switch and a fourth semiconductor switch or a second diode;
one external connection of the second series circuit forms an output-side negative pole of the inverting buck-boost converter; and
a second external connection of the second series circuit is connected to the positive pole of the input voltage;
the inverting buck-boost converter further comprises a second inductance connected to the center connection of the second series circuit and to the center connection between the capacitors.

6. The solar micro-inverter as claimed in claim 4, wherein at least some of the first to fourth semiconductor switches comprise gallium nitride switches.

7. The solar micro-inverter as claimed in claim 6, wherein a switching frequency of the gallium nitride switches is at least 200 kHz.

8. The solar micro-inverter as claimed in claim 4, wherein at least one of the first inductance and the second inductance comprises a circuit board inductance.

9. The solar micro-inverter as claimed in claim 3, further comprising a full bridge connected on the input side to the output-side poles of the boost converter and the inverting buck-boost converter.

10. The solar micro-inverter as claimed in claim 9, wherein the power semiconductors of the full bridge are operated as commutators at least for a part of the operating time.

11. The solar micro-inverter as claimed in claim 1, wherein at least some of the half bridges comprise:
a first semiconductor switch and a second semiconductor switch connected in series;
a controller for the semiconductor switches;
a line originating from a connection node of the semiconductor switches;
a meter for measuring a current in the line;
wherein the controller is programmed to:
compare the current with an upper threshold value and a lower threshold value;
switch off the first power semiconductor if the upper threshold value is reached and to switch on the second power semiconductor after a first dead time has elapsed, and
switch off the second power semiconductor when the lower threshold value is reached and to switch on the first power semiconductor after a second dead time has elapsed.

12. A solar panel comprising:
a panel surface with solar cells;
a frame enclosing the panel surface; and
a solar micro-inverter arranged on the panel surface;
wherein the solar micro-inverter does not protrude beyond the frame.
